(19) United States
(12) Patent Application Publication
(10) Pub. No.: US 2026/0248129 A1
(43) Pub. Date: Aug. 27, 2026

(54) SPRAYABLE SUBSTANCES FOR PHOTOSYNTHESIS ENHANCEMENT

(71) Applicant: Sensei Ag Holdings, Inc., Santa Monica, CA (US)

(72) Inventors: W. Daniel Hillis, Santa Monica, CA (US); Zoe Stephenson, Santa Monica, CA (US)

(21) Appl. No.: 19/489,675

(22) PCT Filed: Jun. 21, 2024
(86) PCT No.: PCT/US2024/035132

§ 371 Date: Dec. 3, 2025

Related U.S. Application Data
(60) Provisional application No. 63/509,752, filed on Jun. 22, 2023.

(51) Int. Cl. A01N 43/16; A01N 25/04; A01N 27/00; A01N 59/00; A01N 63/50; A01P 21/00

(52) U.S. Cl. CPC A01N 43/16; A01N 25/04; A01N 27/00; A01N 59/00; A01N 63/50; A01P 21/00

(57) ABSTRACT

Embodiments of the invention comprise a spray-on substance that harvests components of sunlight that are not very useful in plant photosynthesis and transform them into wavelengths of light that plants can absorb and use. This is done by spraying phosphors or proteins on the plant or on transparent or translucent windows through which the plants are illuminated by sunlight, such as in a greenhouse. The spray can also be combined with substances that enhance plant growth or health, such a pesticide, fungicide, or nutrient.

### CROSS-REFERENCE TO RELATED APPLICATION(S)

This application claims priority to U.S. Provisional Application No. 63/509,752, filed Jun. 22, 2023, which is incorporated by reference herein in its entirety by this reference hereto.

### TECHNICAL FIELD

Various of the disclosed embodiments concern use of sprayable substances for photosynthesis enhancement.

### BACKGROUND

Photosynthetically active radiation (PAR) designates the spectral range (wave band) of solar radiation from 400 to 700 nanometers that photosynthetic organisms are able to use in the process of photosynthesis. This spectral region corresponds more or less with the range of light visible to the human eye. Photons at shorter wavelengths tend to be so energetic that they can be damaging to cells and tissues but are mostly filtered out by the ozone layer in the stratosphere. Photons at significantly longer wavelengths do not carry enough energy to enhance photosynthesis other than by providing warmth.

Chlorophyll, the most abundant plant pigment, is most efficient in capturing red and blue light. Accessory pigments such as carotenes and xanthophylls harvest some green light and pass it on to the photosynthetic process, but enough of the green wavelengths are reflected to give leaves their characteristic color. An exception to the predominance of chlorophyll is autumn, when chlorophyll is degraded (because it contains N and Mg) but the accessory pigments are not (because they only contain C, H and O) and remain in the leaf producing red, yellow, and orange leaves.

In land plants, leaves absorb mostly red and blue light in the first layer of photosynthetic cells because of chlorophyll absorbance. Green light, however, penetrates deeper into the leaf interior and can drive photosynthesis more efficiently than red light. Because green and yellow wavelengths can transmit through chlorophyll and the entire leaf itself, they play a crucial role in growth beneath the plant canopy.

PAR measurement is used in agriculture, forestry, and oceanography. One of the requirements for productive farmland is adequate PAR, so PAR is used to evaluate agricultural investment potential. PAR sensors stationed at various levels of the forest canopy measure the pattern of PAR availability and utilization. Photosynthetic rate and related parameters can be measured non-destructively using a photosynthesis system. PAR sensors measure PAR and sometimes control PAR at set intensities. PAR measurements are also used to calculate the euphotic depth in the ocean.

In these contexts, the reason PAR is preferred over other lighting metrics such as luminous flux and illuminance is that these measures are based on human perception of brightness, which is strongly green biased and does not accurately describe the quantity of light usable for photosynthesis.

However, a considerable amount of photonic energy falls on plants outside of the PAR spectrum at both shorter and longer wavelengths. This photonic energy is not used by plants for growth and it is therefore wasted, and it may also create undesirable heating.

### SUMMARY

Embodiments of the invention comprise a spray-on substance that harvests components of sunlight that are not very useful in plant photosynthesis and transform them into wavelengths of light that plants can absorb and use. This is done by spraying phosphors or proteins on the plants or on transparent or translucent windows through which the plants are illuminated by sunlight, such as in a greenhouse. The spray can also be combined with substances that enhance plant growth or health, such a pesticide, fungicide, or nutrient.

### BRIEF DESCRIPTION OF THE DRAWINGS

FIG. 1 is a graph which shows the spectrum of sunlight that penetrates the atmosphere at sea level;

FIG. 2 is a graph which shows photosynthetic response by photon wavelength from plants in one experiment;

FIG. 3 is a graph which shows a primary photosynthetic absorption spectrum; and

FIG. 4, is a graph that shows absorption spectra of a variety of possible primary and accessory pigments of interest.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### Sprayable Substances for Photosynthesis Enhancement

Embodiments of the invention comprise a spray-on substance that harvests components of sunlight that are not very useful in plant photosynthesis and transform them into wavelengths of light that plants can absorb and use. For example, in embodiments of the invention, IR-to-visible phosphorous is used to enhance the cooling of plants and greenhouses because some of the IR energy goes into photosynthesis instead of heat. In embodiments this is done by spraying phosphors or proteins on the plant or on transparent or translucent windows through which the plants are illuminated by sunlight, such as in a greenhouse. The spray can also be combined with substances that enhance plant growth or health, such a pesticide, fungicide, or nutrient.

Photosynthetically active radiation, or PAR, refers to the portion of the electromagnetic spectrum plants can use for photosynthesis, generally 400-700 nm wavelength light. This corresponds fairly closely with the human visible spectrum. Within the PAR spectrum, certain wavelengths of light are more photosynthetically useful; others, less. Plants use molecules called pigments to absorb photons and convert them into chemical energy. The reason certain colors of light are better or worse for photosynthesis is that pigments absorb photons of some wavelengths better than others. For instance, chlorophylls, which are the main photosynthetic pigments, strongly absorb red and blue photons, but absorb green photons more poorly.

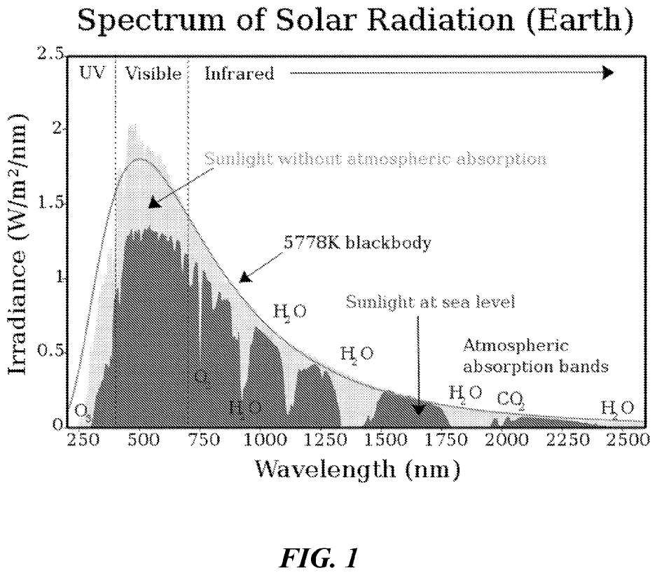

An advantage of converting light to PAR is that while more of the light energy goes into photosynthesis, less goes into to heating, which is advantageous for reducing cooling requirements for greenhouses in hot climates. See FIG. 1, which is a graph in which the portion in red shows the spectrum of sunlight that penetrates the atmosphere at sea level (Source: https://commons.wikimedia.org/wiki/File: Solar spectrum_en.svg).

A refinement of PAR called yield photon flux (YPF), aimed at measuring photosynthetically useful radiation, weights photons in different parts of the 400-700 nm range differently based on a plant's photosynthetic response to those wavelengths. If one is in the position to produce light of particular wavelengths with the goal of enabling photosynthesis, it makes sense to consider measures such as YPF to determine specifically within the PAR spectrum which wavelengths of light are the most useful.

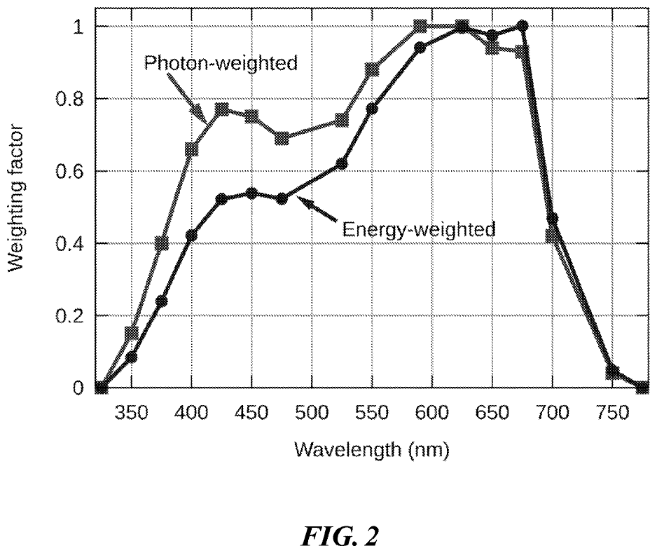

See FIG. 2, which is a graph which shows photosynthetic response by photon wavelength from plants in one experiment. (Source: Wikipedia, “Photosynthetically active radiation,” Weighting factor for photosynthesis. The photon-weighted curve is for converting PPF to YPF . . . ).

However, photosynthetic response is slightly different across the range of all photosynthetic organisms. This is because while chlorophylls are the dominant photosynthetic pigments (especially chlorophyll a, and for our purposes, chlorophyll b), other molecules also contribute to photosynthesis as accessory pigments, in some plant species more than others.

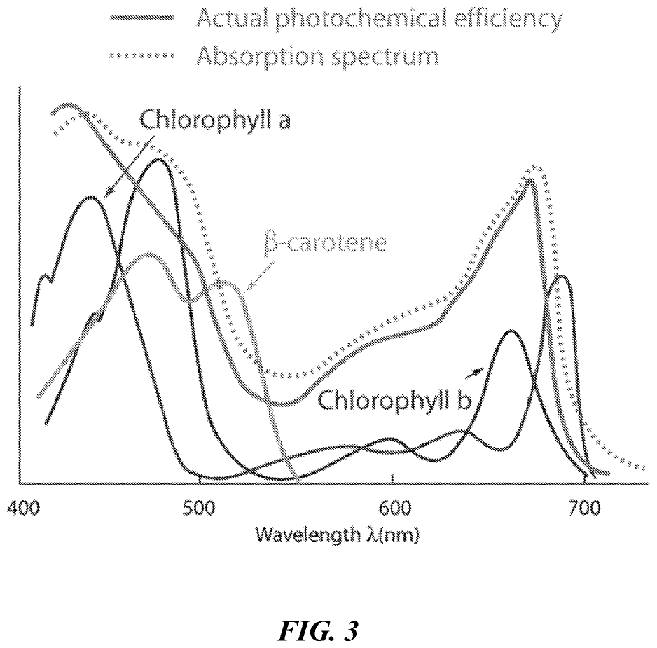

See FIG. 3, which is a graph which shows a primary photosynthetic absorption spectrum (Source: Hyperphysics, “Light Absorption for Photosynthesis,” http://hyperphysics.phy-astr.gsu.edu/hbase/Biology/ligabs.html).

These accessory pigments, e.g., carotenoids, see beta carotene in FIG. 3, also absorb photons and transfer their energy to the photosystem chlorophyll, the protein complex performing photosynthesis. They also perform other functions for plants, as antioxidants, as sensors regulating physiological responses such as seed development, growth towards light (photomorphogenesis), etc. Therefore, depending on the plant species, slightly different compositions of light within the PAR spectrum may be optimal for plant growth.

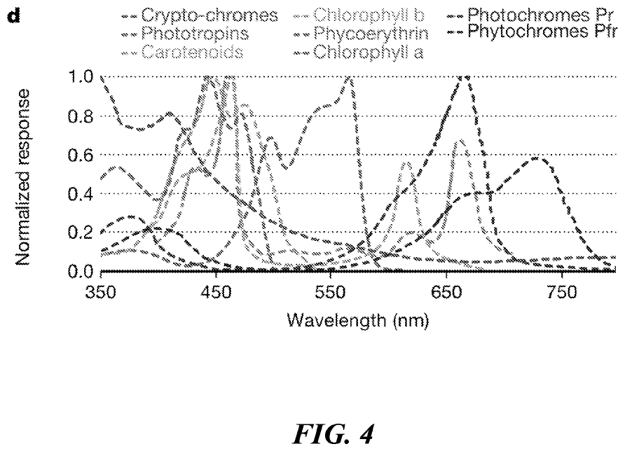

See FIG. 4, which is a graph that shows absorption spectra of a variety of possible primary and accessory pigments of interest (Source: page 3, Pattison, “LEDs for photons, physiology and food:” https://www.energy.gov/sites/prod/files/2020/02/f71/ssl-rd2020-pattison-photons.pdf).

### Phosphors/Fluorophores

Embodiments of the invention use chemical compounds which absorb light outside the PAR spectrum, in the ultraviolet (UV) or infrared (IR) portions where energy from sunlight is still abundant, and which then emit PAR. When these compounds are inorganic and/or synthetic, they are often called phosphors. When they are naturally biologically arising and/or organic, they are often called fluorophores.

Besides visible (i.e., PAR) light, UV (10-400 nm) and IR (700 nm-1 mm) but specifically near-IR light (~700-2500 nm) are the main wavelengths present in the sunlight that makes it through the atmosphere. Other wavelengths of radiation make up only a small proportion of the photonic flux of sunlight which penetrates the atmosphere. Accordingly, UV and near-IR are by far the most appealing wavelengths to target for conversion to PAR/visible light for photosynthesis. Thermal IR photons given off by warm objects or organisms are not very energetic and would have low conversion-to-PAR efficiency. That said, embodiments of the invention may include different compounds than those presented below for converting wavelengths shorter than UV or longer than IR to PAR light. Nonetheless, the examples provided herein all focus on UV or IR because of their abundance and particular suitability.

A general note about fluorescence and its contribution to photosynthesis: Energy originally in photons that was at the wrong wavelength to be absorbed by a photosynthetic pigment represents a pure gain if it can be converted to energy in PAR photons. The energy in the UV photons would never have been available for photosynthesis, but all the energy available in PAR-spectrum fluoresced photons is available for photosynthesis, assuming the photon eventually hits a photosynthetically active tissue. Effectiveness is not diminished by distance from the point of conversion at the phosphor as long as photons do not encounter an opaque obstacle between the phosphor and the photosynthesizing tissue. Photons of a given wavelength have a quantized energy, which is not changed by distance traveled, and are all created equal. It does not matter where the photons came from to the plant using their energy.

There are many families of phosphors and fluorophores. Here are a few examples:

### Organic

Anthracene, a colorless hydrocarbon, fluoresces blue under UV illumination with an emission peak between 400-500 nm. It is slightly soluble in water. It is very soluble in ethanol, methanol, hexane, ether, and a variety of other solvents. It is a solid hydrocarbon which could be applied in a variety of ways, e.g., as a coating on building materials, textiles, or hydroponic growing system components; mixed into transparent building materials such as the skin of a greenhouse; or directly applied to plants. It is biodegradable and does eventually degrade under light.

Coumarin family, e.g., Pacific Blue, Green, and Orange. These fluorophores have absorption peaks around 400 nm, near UV, and they fluoresce at 455, 500, and 551 nm respectively. They are slightly soluble in water. Ether and oil are good solvents; ethanol is a solvent. Coumarin is an organic hydrocarbon synthesized by certain plants as a bitter-tasting deterrent to discourage predator animals from eating said plants. Coumarin family derivatives include a variety of compounds often used as dyes in all the manner dyes are used and could additionally be used in all the same ways as described for anthracene above.

There are many other families of non-protein organic fluorophores with potentially photosynthetically useful fluorescence behavior.

### Rare-Earth

Yttrium oxysulfides, doped with other ions, are the basis for a large family of phosphors, some with Stokes (short to longer wavelength) and some with anti-Stokes (long to shorter wavelength) luminescence. These can convert, respectively, ultraviolet light down to photosynthetically active radiation via a Stokes shift or infrared light the other way, up to PAR, via an anti-Stokes shift. Some phosphors even do both. For example, the family of phosphors created from yttrium oxysulfide doped with specific proportions of ytterbium, erbium, titanium, and magnesium following the general formula of:

$${Y}_{1.975 - x} {Yb}_{0.025} {Er}_{x} {O}_{2} S : {Ti}_{0.12} {Mg}_{0.04} , 0 \leq x \leq 0.1 ,$$

produces a variety of potentially photosynthetically useful phosphorescence behaviors depending on the ratios of the dopants, per Georgobiani, A. N. et al. (2007). A New Multifunctional Phosphor Based on Yttrium Oxysulfide. Inorganic Materials, 43(10): 1073-1079. https://doi.org/10.1134/S0020168507100093. Accessed Jun. 21, 2023. The relative ratios of each element in the compound are given by the numbers in the subscripts of the chemical formula. For instance, in the case where x is held to zero, the formula reads, “1.975 parts yttrium to 0.025 parts ytterbium to 0 parts erbium to 2 parts oxygen to 1 part sulfur to 0.12 parts titanium to 0.04 parts magnesium.” This family of phosphors is a super-family combination of independently useful phosphor sub-families: yttrium oxysulfide doped with other rare earths, e.g., Y₂O₃S:Yb³⁺, Er³⁺, and yttrium oxysulfide doped with the lighter metals, e.g., Y₂O₃S:Ti, Mg.

Yttrium oxysulfide phosphors as with those in the family of interest may be created by a variety of methods. These include heating oxides of the base material and dopants, i.e., in this case, Y₂O₃ plus Yb₂O₃, Er₂O₃, TiO₂, MgO, in a sulfurizing atmosphere (with H₂S, or CS₂, or H₂S+_{N}2+H₂O), or reducing the yttrium sulfate and dopant sulfates with hydrogen gas or carbon monoxide, ball milling the above-listed oxides with sulfur, or sulphuration of the above oxides in a flux. This last is a more common mass-production process. Fluxes usually include an alkali carbonate or phosphate, e.g., sodium, potassium or lithium carbonate, lithium or potassium phosphate, and a sulfur source, e.g., a sodium polysulfide Na₂Sₓ, and may be performed under a sulfur dioxide or other sulfurizing atmosphere.

Once produced, this family of phosphors produces light as follows: Under UV illumination, it luminesces yellow with peaks around 408-425, 520-570, and 650-680 nm. In the wake of UV illumination, Ti and Mg ions also produce afterglow in red-orange around 626 nm. Under IR illumination, Yb³⁺ ions absorb in the 0.9 to 1.0 micron range and Er³⁺ ions absorb longer IR in the 1.5-1.6 micron range, producing luminescence bands around 530, 550, and 660 nm (max at 546); and mostly 650-680 nm (max at 670) respectively. Notably, both UV and IR fluorescence may be tuned to some extent by the Er³⁺ content of the phosphor, where increasing Er³⁺ causes sharper emission peaks at certain color bands, which may be a useful feature for tuning light emission to particular plant needs. Note: as previously described, the formula Y_{1.975-x} Yb_{0.025}ErₓO₂S:Ti_{0.12}Mg_{0.04}, 0≤x≤0.1 encodes a family of phosphors where x in the formula is a variable. By including different amounts of Er during the synthesis and otherwise following the same synthesis procedure, a phosphor of different proportions of Y vs Er is produced (see research by Georgobiani).

Other compounds are bases for interesting families of phosphors, too. Strontium aluminates and strontium sulfides, doped with other ions, can produce, respectively, blue-green and red phosphors under steady UV excitation. For instance, in Sr₄Al₁₄O₂₅, doping with europium (Eu²⁺) ions produces steady-state luminescence, long-persistent phosphorescence and photostimulated luminescence in the photosynthetically useful range of 475-525 nm, i.e., blue-green. Additional dopants, for instance, thulium, dysprosium, and lanthanum, in addition to europium, may tune the relative intensities of different types of luminescence. For instance, see Sr₄Al₁₄O₂₅:Eu, Tm; Sr₄Al₁₄O₂₅:Eu, Dy, Tm; Sr₄Al₁₄O₂₅:Eu, Tm, La, (where the relative ratios of each element are given by the subscripts before the colon, and doped ions after the colon are not at a rigid ratio). (Manashirov, O Ya., et al. (2013). A New Photostimulated Strontium-Aluminate-Based Blue-Green Phosphor. Inorganic Materials, 49(5): 487-491. https://doi.org/10.1134/S0020168513040080. Accessed Jun. 21, 2023.)

The spectrum tunability of inorganic phosphors by quantity of dopant ions might be used to create optimal phosphor blends for different plants based on the photosynthetic pigments active in a given organism (see FIGS. 3 and 4) by tuning the phosphor or fluorophore to emit wavelengths that are most efficiently absorbed and used by that particular organism for photosynthesis, or even for inhibition or promotion of particular growth modes or other biological processes based on incident light color.

In addition to known chemical-formula phosphors described in literature, various companies advertise proprietary and even custom blending of what are almost certainly inorganic and likely specifically rare-earth phosphors available commercially. For example, references:
Luminochem LUUPC&/2: absorbs infrared 980 nm, emits green. “Security taggant”: https://luminochem.com/lproduct/luupc7-2/; and
Mt-Berlin: http://www.mt-berlin.com/frames_cryst/descriptions/antistokes.htm.

Such a spectrum-shifting spray may also be used change the light spectrum to improve the morphology of plant growth.

A spray that enhances the far-red Light Spectrum (700-850 nm) may be used to enhance a plant's shade response, which enhances stretching of stems and leaves.

A spray that enhances the green light spectrum (500-600 nm) may be used to allow more light to penetrate a plant's canopy, such that additional green light applied to windows promotes growth in lower leaves of the plant.

A spray that enhances the blue light spectrum (400-500 nm) may be used to promote the stomatal opening, which allows more CO2 to enter the leaves and tends to reduce stem stretching.

Different phosphor compounds could be applied to plants or surfaces near plants during different phases of the same plant's growth cycle to achieve different desirable effects based on the growth stage of the plant.

### Application of the Phosphors to Plants and Windows

### Phosphor Application as a Sprayed Liquid

Greenhouses and farms regularly make use of a range of spraying equipment, from handheld units to multi-row automated machines, to evenly apply pesticides, herbicides, and fungicides.

Non-limiting examples of agricultural sprayer equipment include:
Handheld+wheeled unit: https://www.dramm.com/html/main.isx?sub=438; and
Automated whole-row unit: https://micothon.nl/custom-built-solutions/strawberry-runner-sprayer/.

### Dissolved in Liquid

One ideal solvent for applying to plants is water because it is applied very regularly as a diluent of pesticides, has a nil to mildly supportive effect, and is very difficult to over-dose. The organic phosphors listed do not have very good water solubility (anthracene: 0.044 mg/L water at 25° C., very poor; coumarin: 0.17 mg/100 mL water) but do technically have some; some amount of phosphor could be applied that way.

The organic phosphors listed are very soluble in some other common solvents which quickly evaporate after application: methanol, ethanol, hexane, and some light oils.

Light oils are sometimes used in foliar applications of pesticide to produce prolonged coatings in pest control.

Hexane probably falls between the category of light oil and methanol/ethanol, below, because it is technically an oil but is a very small molecule which evaporates quickly. Many organic phosphors have good hexane solubility. Hexane-based solutions would need to be applied more selectively than water-based solutions but might have uses in some applications.

Methanol and ethanol, as carbon sources, are actually promoters of plant growth as stimulants which produce overall bigger plants and are already used as components of regularly applied pesticides. Using either or both as solvents combines two positive effects.

The exact ratio of the phosphor/fluorophore to the solvent is not critical. Higher concentrations of phosphor/fluorophore create a larger enhancement effect. The amount of the phosphor that can be dissolved in the solvent is limited by its solubility in the particular solvent. Higher quantities of surface deposition may be achieved by multiple coats of a spray.

### Emulsification

Hydrocarbons generally have poor solubility in water, but with mixing, they may be emulsified into it or into other liquids. The organic phosphors listed above are good candidates for emulsification in a variety of carrier fluids.

Emulsification is a process, sometimes purely mechanical and sometimes chemically aided, by which two liquids that would not normally combine (which are immiscible) are combined in a suspension. That is to say, very tiny droplets of one liquid are dispersed within the other liquid to form what on a macroscopic scale seems to be a single-substance mixture. Examples of emulsions include milk or various oil-in-water sauces such as salad dressings or mayonnaise.

Emulsions may be created simply by vigorous mixing. However, over time emulsions do eventually revert to their un-mixed state. In embodiments of the invention, the lifetime of phosphor/carrier-fluid emulsion does not need to be stable for very long. All that is needed is for the phosphor to stay in the carrier fluid long enough to be sprayed over plant leaves or desired near-to-plant building or growing container surfaces. In fact, a short, stable lifetime may actually have benefits in terms of allowing the carrier fluid to evaporate more quickly.

If longer stability is desired, an emulsifier may be added to the mix. An emulsifier is a compound with two chemically dissimilar ends, one of which mixes well with the first liquid and the other of which mixes well with the second. Usually, and in embodiments of the invention, this would be a hydrophilic (water-loving, polar-compound-soluble) end and a hydrophobic (water-hating, nonpolar/hydrocarbon-soluble) end. Examples of emulsifiers include soap, lecithin (a compound from egg yolks, soybeans, and various other foods), etc. Small amounts of emulsifiers can stabilize an emulsion for greatly increased periods of time.

### Colloidal Suspension

Colloidal suspension (or simply an agitated mixture): The rare-earth phosphors listed above are good candidates for application to plant surfaces in colloidal/agitated mixture form.

Some rare earth phosphors may be broadly insoluble in reasonable solvents when powdered. However, one might still use a sprayed liquid to apply them to plant surfaces by creating a colloidal suspension of microscopic phosphor particles within a carrier fluid of choice.

A colloid is much like an emulsion, except where in an emulsion the dispersed phase is a liquid, in a colloid the dispersed phase is a solid. Think, for example, of pigmented ink.

Colloids that are not formed by chemical reactions (not applicable here) are formed, just as emulsions are, by vigorous mixing.

As with emulsions, colloid stability over time is always a question. Fortunately, in embodiments of the invention, one need not have something at all long-lasting. A recently agitated mixture of phosphor powder and carrier liquid sprays or casts well, even if the solid phase immediately settles out of the liquid when the droplets land. This settling out of solution once on the leaf structure would not affect phosphor function. It may even have advantages in terms of allowing the carrier fluid to evaporate more quickly.

In embodiments of the invention, sprayers may be modified to have a mixing impeller immediately before the nozzle; the stable lifetime of the colloidal suspension need only be the impeller-to-nozzle travel time.

If desired, milling the dispersed phase, i.e., the phosphor, into smaller particles could extend the stability of the colloidal suspension.

### Phosphor Application as a Fan-Blown Powder

The rare-earth phosphors listed above, which form solids, are a good candidate for milling into a fine dust and applying via fans.

Greenhouses regularly make use of blowing systems for applying beneficial substances evenly over the surface of crops, e.g., beneficial insects.

Example hand-blowers (see https://www.koppertus.com/mini-airbug/and https://www.koppertus.com/airbug/).

Example fully automatic fans (see https://www.koppertus.com/airobug/).

Finely powdered phosphors, often sold at ~2 micron particle size, could be evenly blown with a similar air system uniformly over crops in a field or greenhouse.

### Phosphor Application as a Coating or an Integral to Structural Components

Phosphor application may be made as a mixed-in component of a clear paint, lacquer, or anodizing coating with which inert structures in a greenhouse or farm environment are coated.

Any type of phosphor listed here might be applied this way. Paints could be permanent or periodically refreshed. A liquid as described in the sprayed liquid section above could also be used as a paint for structural components. Phosphor application may also be made as a component of clear greenhouse or machinery parts mixed in during casting or molding, e.g., as a phosphorescent glass or plastic roofing or side panel (see https://www.sumita-opt.co.jp/en/products/luminous-glass.html).

### Proteins

Proteins may be also used to transform components of sunlight that are not very useful in plant photosynthesis into wavelengths of light that plants can absorb and use. For example, green fluorescent protein, found in various ocean life forms, absorbs UV light at 395 nm and emits green light at 509 nm (avGFP). Significantly, proteins can be used to make a nontoxic spray which, if desired, can be made such that it degenerates over time in the light. Thus, after they do their job, they decay or can be washed away. It is possible to engineer proteins very well using modern computer techniques. All chemical interactions with photons have to do with the size and energy of the molecular orbitals present in a given molecule and the energy differences between orbitals. In the case of visible (i.e., PAR) light, the applicable orbitals are conjugated pi bond systems populated with delocalized, or resonance, electrons. Conjugated pi bond systems have different configurations dependent on the specific wavelength of interest. Starting with an existing protein like green fluorescent protein, conjugated pi systems relevant to fluorescence may be identified, modeled, and molecular structure changes simulated to change desired absorption or emission light wavelength. The genetic changes to the DNA sequence that would produce a modified protein may often be backed out, and gene editing tools including CRISPR may be used to modify the genes' coding for the protein into a new form which may code the desired modified protein. These genes might then be transferred via plasmid to easily cultured bacteria for practical protein production.

Proteins have the potential to be most useful for spraying on plants, as opposed to a phosphor, which typically uses rare earth and therefore tends to be more expensive, as well as being more difficult to tune to exactly the right frequencies. There is more flexibility in tuning proteins to resonate at a desired frequency.

The same techniques which can be used to modify fluorescent proteins to change absorption/emission wavelength by modifying conjugated pi bond systems could also be used to modify inherent plant pigments to change absorption wavelengths of photosynthetic molecules of the plant itself. While it is likely most efficient for most current growing applications to maintain plant pigments in their evolved ratios and absorbing at their evolved wavelengths and simply increase the available light at those wavelengths, the ability to modify the plant's own photon absorption in the photosystem should not be overlooked. Applications outside the atmosphere (growing plants on satellites in orbit or on other Solar System bodies) would particularly benefit from this technique.

### Example I: Spray-On Solution

Prepare a solution of Pacific Orange dye (“Pacific Orange dye,” 2023) in ethanol and water (“Aliphatic Alcohols,” 1995) at the dilution rate of 0.5 grams dye per 50 milliliters ethanol plus 950 milliliters water, mixing 1 gallon of solution per 250 square feet of planted crops. Apply evenly to photosynthesizing surfaces of plants with a hydraulic sprayer before fruit is set. See, e.g., HYDRA Hydraulic Sprayers. (2023). Dramm Corporation. https://www.dramm.com/html/main.isx?sub=438. Accessed Jun. 21, 2023. Alternately, apply to greenhouse surfaces surrounding plants (windows, walls, growing containers, other hardware) with as many coatings and as high a concentration as is economically valuable.

The solution is not explicitly removed, though if desired the plant or certain surfaces of the plant could be sprayed down with the same solvent or a different solvent to wash off the treatment. It does break down over time in sunlight and can slough off the leaf. In embodiments of the invention the solution can be applied at a rate of one gallon per 250 ft\hat{ }2 planted crops.

### Example II: Spray-On Solution

Prepare a suspension of finely powdered Y1.955Yb0.025Er0.02O2S:Ti0.12Mg0.04 phosphor (ideally 5-micron particle size or smaller) in water with Agral 90 surfactant (“Agral 90,” 2019), at the dilution rate of 1 gram powdered phosphor and 1 milliliter Agral 90 per 3 liters water, mixing 1 gallon of solution per 250 square feet of planted crops. Using a hydraulic sprayer retrofitted with a mixing impeller between the storage tank and the intake pressurization pump or an overhead misting system, apply evenly to photosynthesizing surfaces of plants before fruit is set. Alternately, apply to greenhouse surfaces surrounding plants (windows, walls, growing containers, other hardware) with as many coatings and as high a concentration as is economically valuable.

### Example III: Cast into a Greenhouse Window

During the polycarbonate sheet or film production, after resin is melted but before sheet is extruded, mix in finely powdered Y_{1.955} Yb_{0.025}Er_{0.02}O₂S:Ti_{0.12}Mg_{0.04} at desired concentration. Continue casting as normal. Install sheet as a greenhouse window. Use film to cheaply cover growing container surfaces, doors, walls, or internal building structure and make phosphorescent.

### Other Considerations

The frequency of use of the light-transforming mixture depends on how quickly it degrades. In some embodiments of the invention, specifically in use directly on plants, it is desirable to have a light-transforming mixture that degrades. Fortunately, organic phosphors tend to degrade over time in heat and sunlight. If proteins are used, they can be tuned to degrade with sunlight.

It is preferable that the light-transforming mixture is nontoxic. Alternatively, the light-transforming mixture can be washed off of the plants or specific areas of plants with the same carrier solvent used to apply it, or a soap solution with good affinity for the phosphor. Parts of the plant which are not eaten, e.g., leaves of a fruiting plant, may not require this treatment even if eating the light-transforming mixture is undesirable. The application of the light-transforming mixture may also be isolated in time or space from the edible part of the plant, e.g., isolation in time: spraying before fruit is set, or spraying sufficiently far ahead of harvest that the fluorophore compound has broken down by harvest time, e.g., isolation in space: spraying only above the soil for a root crop.

In application where the light-transforming mixture is sprayed on the windows or mixed into transparent components, e.g., in greenhouse structural components, it is preferred that the light-transforming mixture not degrade. The inorganic phosphors as described above are more resistant to degradation in sunlight. Data that shows it is effective even if not directly on the plant. In some embodiments of the invention it might be better not to spray it on the plant. Distance from the plant does not matter if the photons travel from wherever the light is emitted to a photosynthetically active part of the plant.

### Applying Non-PAR-to-PAR-Converting Phosphors on Plants or in Proximity to Plants in a Sprayable Liquid Carrier Fluid for Even Dispersal.

Liquids sprayed on crops are very regulated because of human health effects.

There are a number of foliar, i.e., on-the-leaves, spray substances for crops which are already approved and even ones which actually enhance plant growth (methanol, ethanol e.g.)

Mechanical engineering uses mixing impellers, agitators, and similar devices to mix non-homogeneous mixtures as well as move them along through a liquid delivery system.

Embodiments of the invention use existing industrial mechanisms to create a suspension (if with large particles) or a colloidal emulsion or sol (if with smaller particles—this would have a longer persistence time) of a phosphor to be used for a given plant growth application in whatever carrier fluid desired, including water (which has the huge advantage of not being regulated in its application), in a pre-approved growth promoter, or in another existing approved foliar spray, regardless of chemical incompatibility of the phosphor and the carrier fluid.

This makes it possible at all for the inorganic phosphors able to be applied in a spray form and hugely increases flexibility with which organic phosphors are used and how and when they can be used.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

I/We claim:

1. A method of enhancing photosynthesis, comprising:
preparing a composition comprising any of a phosphor, a fluorophore, and a protein; and
applying the composition to a surface;
wherein the composition converts non-photosynthetically active radiation into photosynthetically active radiation (PAR) that is usable by a plant for photosynthesis by absorbing light outside the PAR spectrum, in the ultraviolet (UV) or infrared (IR) portions where energy from sunlight is abundant, and then emitting PAR.

2. The method of claim 1, wherein said composition comprises a spray-on substance that harvests components of sunlight which are not useful in plant photosynthesis and transforms them into wavelengths of light that plants can absorb and use.

3. The method of claim 1, further comprising:
using IR-to-visible phosphorous to enhance cooling of plants and greenhouses wherein some of the IR energy goes into photosynthesis instead of heat.

4. The method of claim 1, wherein said applying comprises spraying phosphors or proteins on a plant or on a transparent or translucent window through which the plant is illuminated by sunlight.

5. The method of claim 1, further comprising:
combining said composition with a substance that enhances plant growth or health.

6. The method of claim 1, wherein said composition comprises:
anthracene, a colorless hydrocarbon, that fluoresces blue under UV illumination with an emission peak between 400-500 nm, is slightly soluble in water, is very soluble in ethanol, methanol, hexane, and ether, is biodegradable, and eventually degrades under light.

7. The method of claim 1, wherein said composition comprises:
a Coumarin family fluorophore comprising any of Pacific Blue, Green, and Orange having an absorption peak around 400 nm, near UV, and fluorescing at 455, 500, and 551 nm respectively.

8. The method of claim 1, wherein said composition comprises:
yttrium oxysulfides, doped with other ions and having any of Stokes (short to longer wavelength) and anti-Stokes (long to shorter wavelength) luminescence;
wherein said yttrium oxysulfides convert, respectively, ultraviolet light down to PAR via a Stokes shift, or infrared light up to PAR, via an anti-Stokes shift, or both.

9. The method of claim 1, further comprising:
strontium aluminates and strontium sulfides, doped with other ions, that produce, respectively, blue-green and red phosphors under steady UV excitation.

10. The method of claim 1, further comprising:
spectrum tuning said composition with dopant ions to create optimal phosphor blends for different plants based on the photosynthetic pigments active in a given plant by tuning the phosphor or fluorophore to emit wavelengths that are most efficiently absorbed and used by that particular plant organism for photosynthesis.

11. The method of claim 1, wherein said composition comprises:
a spectrum-shifting spray that changes the light spectrum to improve the morphology of plant growth;
wherein said spray performs any of:
enhancing the far-red light spectrum (700-850 nm) to enhance a plant's shade response and enhance stretching of stems and leaves;
enhancing the green light spectrum (500-600 nm) to allow more light to penetrate a plant's canopy, wherein additional green light applied to windows promotes growth in lower leaves of the plant; and
enhancing the blue light spectrum (400-500 nm) to promote the stomatal opening, which allows more CO2 to enter the leaves and reduces stem stretching.

12. The method of claim 2, wherein said composition is applied with a sprayer comprising any of:
a handheld+wheeled sprayer; and
an automated whole-row unit.

13. The method of claim 12, wherein said sprayer further comprises:
a mixing impeller immediately before a sprayer nozzle.

14. The method of claim 1, wherein said composition further comprises:
a solvent for applying said composition to plants, said solvent comprising any of water, methanol, ethanol, and hexane.

15. The method of claim 1, wherein said composition further comprises:
an emulsifier.

16. The method of claim 1, wherein said composition further comprises:
a colloidal suspension.

17. The method of claim 1, wherein said composition is applied as a fan-blown powder.

18. The method of claim 1, wherein said composition comprises a mixed-in component of a clear paint, lacquer, or anodizing coating with which inert structures in a greenhouse or farm environment are coated.

19. The method of claim 1, further comprising:
combining a dispersed medium comprising said composition with a dispersal medium comprising a substance that enhances plant growth or health, wherein said substance is combined with said composition without respect to chemical compatibility of said substance with said composition;
applying said substance and said composition together by any of a mixing impeller or agitator immediately before an applicator comprising a sprayer nozzle to create a suspension, colloidal emulsion, or colloidal sol for application to said surface;
wherein the dispersion medium and the dispersed medium are selected independently from one another for their independent desired effects on plants.

20. A photosynthesis enhancing composition, comprising:
any of a phosphor, a fluorophore, and a protein present in a predetermined ratio to convert non-photosynthetically active radiation into photosynthetically active radiation (PAR) that is usable by a plant for photosynthesis by absorbing light outside the PAR spectrum, in the ultraviolet (UV) or infrared (IR) portions where energy from sunlight is abundant, and then emitting PAR; and
a dopant, wherein the dopant is present in a predetermined ratio to encourage phosphorescence.

21. The composition of claim 20, wherein said dopant comprises dopant ions effecting spectrum tuning to create optimal phosphor blends for different plants based on the photosynthetic pigments active in a given plant by tuning the phosphor or fluorophore to emit wavelengths that are most efficiently absorbed and used by that particular plant organism for photosynthesis.

22. The composition of claim 20, further comprising:
anthracene, a colorless hydrocarbon, that fluoresces blue under UV illumination with an emission peak between 400-500 nm, is slightly soluble in water, is very soluble in ethanol, methanol, hexane, and ether, is biodegradable, and eventually degrades under light.

23. The composition of claim 20, further comprising:
a Coumarin family fluorophore comprising any of Pacific Blue, Green, and Orange having an absorption peak around 400 nm, near UV, and fluorescing at 455, 500, and 551 nm respectively.

24. The composition of claim 20, further comprising:
yttrium oxysulfides, doped with other ions and having any of Stokes (short to longer wavelength) and anti-Stokes (long to shorter wavelength) luminescence;
wherein said yttrium oxysulfides convert, respectively, ultraviolet light down to PAR via a Stokes shift, or infrared light up to PAR, via an anti-Stokes shift, or both.

25. The composition of claim 20, further comprising:
strontium aluminates and strontium sulfides, doped with other ions, and that produce, respectively, blue-green, and red phosphors under steady UV excitation.

26. The composition of claim 20, further comprising:
a solvent for applying said composition to plants, said solvent comprising any of water, methanol, ethanol, and hexane.

27. The composition of claim 20, further comprising:
an emulsifier.
